(19) United States
(12) Patent Application Publication
(10) Pub. No.: US 2022/0093010 A1
(43) Pub. Date: Mar. 24, 2022

(54) LABELED ARTICLES INCLUDING SMART COMPONENTS

(71) Applicant: Multi-Color Corporation, Batavia, OH (US)

(72) Inventor: David M. Uland, Granville, OH (US)

(21) Appl. No.: 17/482,544

(22) Filed: Sep. 23, 2021

Related U.S. Application Data
(60) Provisional application No. 63/082,058, filed on Sep. 23, 2020.

(51) Int. Cl. G09F 3/02

(52) U.S. Cl. CPC G09F 3/02; G09F 2003/0257; G09F 2003/023

(57) ABSTRACT

Apparatus and methods for protecting smart components associated with articles and packaging of articles, including articles and packages labeled with shrink sleeve labels, pressure sensitive labels, and other labels.

### CROSS-REFERENCE TO RELATED APPLICATION

This application claims the benefit of the filing date of U.S. Patent Application Ser. No. 63/082,058, filed on Sep. 23, 2020, the disclosure of which is incorporated by reference herein in its entirety.

### FIELD OF THE INVENTION

The present invention generally relates to smart components associated with various articles and used in packaging of articles, and particularly to methods of protecting such smart components when associated with articles and/or packaging.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Over the past several years, packaging companies have been embedding smart components (smart devices) in packaging because, among other reasons, it is a simple way to scale implementation. Such smart components may include, but are not limited to, electronic article surveillance (EAS) tags, radio frequency identification (RFID) tags, near field communication (NFC) tags, and some internet of things (IoT) tags. When associated with packaging, the smart component (e.g., electronic circuitry such as an antenna, semiconductor chips, capacitors, resistors, etc.) is generally contained in one layer of the packaging.

Recently, it has become popular to decorate articles, or packages containing articles, using shrink sleeve labels. These labels include a shrink film that typically includes decoration (such as visible graphics, text, and/or other indicia). These shrink films can be applied to cover the entire article or package, and can conform to innovative shapes, which may be more attractive to buyers at the point of purchase.

The process of shrink labeling an article involves sizing a shrink film, which may be a tubular shrink sleeve, to a particular article. Then one shrinks the film to snugly wrap the article within the shrink sleeve. The shrinking process is generally accomplished by the application of heat or steam to the shrink sleeve. The film has an inherent tension that is released by heating the film from the outside in a shrink oven. As the film is heated, it shrinks snugly around the article. This shrinkage applies a pressure to the article, which aids in holding the shrink film to the article. In alternate embodiments, an adhesive may be applied to the inner surface of the shrink sleeve.

One problem that arises with shrink films with respect to smart components is that, when the film is heated and shrinks to conform with the article, it applies pressure to anything trapped between the outer surface of the article and the inner surface of the shrink film. It is desired to put smart components (e.g., EAS tags, RFID tags, NFC tags, etc.) between the shrink film and the article, to hide the component from consumer perception and make it difficult to remove without obvious damage to the label, article, and/or package. However, some of these components (or portions of them) may lose performance (or experience reduced performance) under the pressure from the shrink film.

Similar issues with reduced functionality of smart components may exist with the use of other types of labels for articles or packaging, such as application of pressure sensitive labels (or other types of labels) to articles or packaging that includes smart components.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

Aspects of the present invention provide a method for protecting smart components when being associated with packaging, and provide for labeled articles and/or packaging including smart components that overcome the drawbacks described above.

In that regard, one aspect of the present invention provides the ability to provide stress relief to smart components associated with articles or packaging (or a sensitive portion or portions of such smart components), when applying a label or labels to such articles or packaging. For example, one such type of smart component is an EAS tag. As described above, issue arise when labeling articles or packaging that includes EAS tags. The various physical dimensions of EAS tags are sensitive, such that the functionality for such tags can be disrupted, reduced, and/or eliminated when subjected to dimensional change. Such dimensional change may occur with the application of labels that results in stress being applied to the EAS tag (or other smart component). One type of label that may apply stress to such a smart component is a shrink sleeve label (though the present invention is not limited to shrink sleeve labels). Aspects of the present invention, however, provide a method for applying the label (or applying the label relative to the smart component) in such a way that the component (e.g., tag—where a chip is for an NFC or RFID tag or where element of an EAS tag resides) as applied is not subjected to stress that would affect its functionality.

These and other advantages of the application will be apparent to those of skill in the art with reference to the drawings and the detailed description below.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1A shows an embodiment of a shrink sleeve label formed from a shrink film, and having a smart component associated therewith.

FIG. 1B shows an embodiment of an article to be labeled, with the article having a relief formed therein.

FIG. 2 shows the shrink sleeve label of FIG. 1A as applied to the article of FIG. 1B.

FIG. 3 is a cross section view of a label including a cutout region in a layer thereof, adapted to retain a smart component.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, aspects of the present invention provide a method for protecting smart components when being associated with packaging, and provide for labeled articles and/or packaging including smart components that overcome the drawbacks described in the Background section.

In that regard, one aspect of the present invention provides the ability to provide stress relief to smart components associated with articles or packaging (or a sensitive portion or portions of such smart components), when applying a label or labels to such articles or packaging. For example, one such type of smart component is an EAS tag. As described above, issue arise when labeling articles or packaging that includes EAS tags. The various physical dimensions of EAS tags are sensitive, such that the functionality for such tags can be disrupted, reduced, and/or eliminated when subjected to dimensional change. Such dimensional change may occur with the application of labels that results in stress being applied to the EAS tag (or other smart component).

One type of label that may apply stress to such a smart component is a shrink sleeve label (though the present invention is not limited to shrink sleeve labels, and may encompass other types of labels, e.g., pressure sensitive labels). Aspects of the present invention, however, provide a method for applying the label (or applying the label relative to the smart component) in such a way that the component (e.g., tag—where a chip is for an NFC or RFID tag or where element of an EAS tag resides) as applied is not subjected to stress that would affect its functionality.

One embodiment that addresses this issue is an embodiment that locally prevents—or relieves—the pressure on a smart component (e.g., EAS tag) by (1) providing a relief in the article or package, (2) aligning the smart component (or components which are sensitive to pressure) with the relief, and then (3) applying a label to the article or package.

For example, when an article is molded, a relief (e.g., including, but not limited to, an indentation, depression, dimple, dent, cavity, notch, etc.) is formed in the article that is larger than a component (according to the manufacturing tolerances)—the component being an EAS tag in this example. The size and/or configuration of the relief formed may be similar to that of the EAS tag to be positioned therein (and sized to receive the EAS tag). The EAS tag is then positioned such that it will be disposed within the relief. A label may then be applied over at least the area of the relief. For example, the label to be applied may be a shrink sleeve label (having a shrink film that is placed around the article and then shrunk to the article). Thus, when the film shrinks, the EAS tag is trapped between shrink film and article—but is not subjected to levels of stress that may disrupt functionality of the EAS tag, because it is positioned within the relief.

Though the above describes the entire smart component (e.g., EAS tag) as disposed within the relief, it may only be a portion (or portions) of a smart component that is sensitive to pressure (such that functionality of the smart component may be disrupted). An example of such a portion of a smart component is the fuse blowing focal point in an EAS tag. And so, in other embodiments, the relief may be formed, and the smart component positioned relative thereto, such that at least the sensitive portion (i.e., the fuse blowing focal point in this example) is positioned in the relief. In this embodiment, other portions of the EAS tag may perhaps not be positioned within, or otherwise associated with, the relief).

As another specific example, an RFID semiconductor is a type of smart component that may be embedded in an article or packaging as part of an RFID inlay. Such a semiconductor may be as small as a hundred microns or as large as 6 mm on an edge. In this example, the article to be associated with the RFID semiconductor may be a bottle. In accordance with aspects of the invention, when the bottle is molded, a relief (e.g., an indentation, depression, dimple, dent, cavity, notch, etc.) is formed in the bottle that is larger than the semiconductor (according to the manufacturing tolerances). The size and/or configuration of the relief formed may be similar to that of the smart component to be positioned therein (and sized to receive the smart component). The RFID semiconductor is then positioned such that it will be disposed within the relief. A label may then be applied over at least the area of the relief. For example, the label to be applied may be a shrink sleeve label (having a shrink film that is placed around the article and then shrunk to the article). Thus, when the film shrinks, the semiconductor is trapped between shrink film and article—but is not subjected to levels of stress that may disrupt functionality of the RFID semiconductor, because it is positioned within the relief.

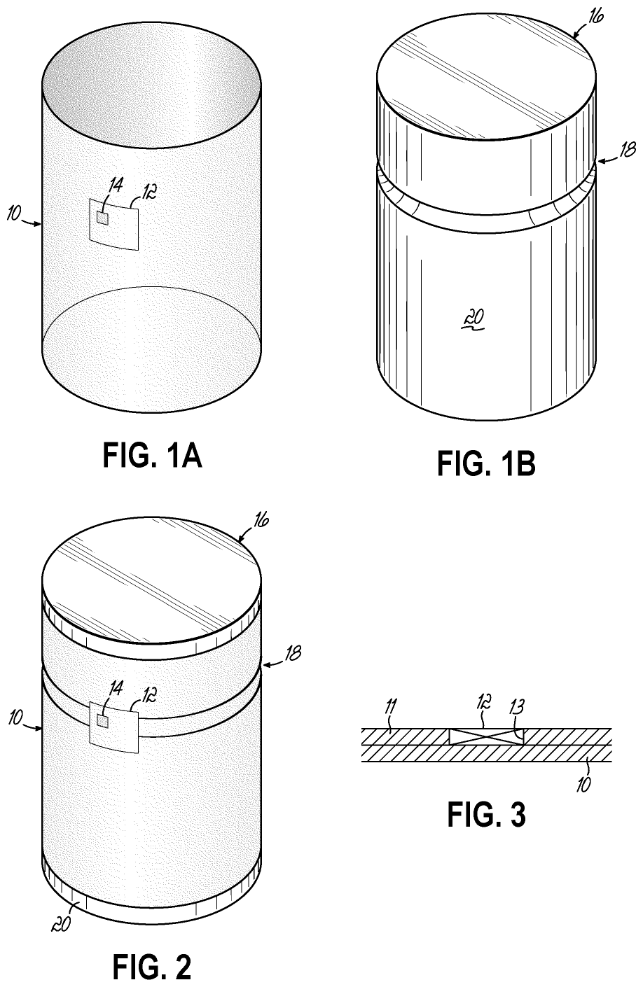

Referring now to the Figures, one embodiment of a labeled article including a smart component—and a process for labeling such article—is shown. As shown in FIG. 1A, a shrink sleeve label 10 (formed from a shrink film) has a component 12 (such as a smart component) associated therewith. The component 12 includes at least one pressure-sensitive area 14. FIG. 1B shows an article 16 to be labeled. The article 16 includes a relief 18 associated therewith—such as by being formed in a surface 20 of the article 16. FIG. 2 shows the shrink sleeve label 10 of FIG. 1A (including component 12) applied to the article 16. When applied, the shrink sleeve label 10 is aligned relative to the article 16 such that the pressure-sensitive area 14 of the component 12 is aligned with the relief 18. As a result, once the shrink sleeve label 10 is exposed to heat to shrink around the article 16, the pressure-sensitive area 14 aligns with, or is disposed within, the relief 18, thereby reducing or eliminating pressure that might affect functionality.

When a relief is formed in an article or package to be labeled, there may be various embodiments of methods of aligning a smart component with the relief for positioning the smart component within the relief. Further, there may be various embodiments of the relief itself.

Regarding aligning a smart component with a relief: In one embodiment (such as that shown in FIGS. 1A, 1B, and 2), positioning the smart component in the relief of an article or packaging may be accomplished by applying the component to the inside of a label, and then aligning the label during label application such that the component is in register with the relief in the article or packaging. As a result, as the label is applied to the article or package, the component will be positioned within the relief. For example, the component can be applied to one side of a shrink film that is rolled, or folded over on itself, and seamed to form a shrink sleeve label with the component on an inner surface of the shrink sleeve label. In the example where the article is a bottle, the sleeve is then positioned relative to the bottle to align the component to the molded feature (i.e., the relief) in the bottle during application of the shrink sleeve label thereto. The component itself may be in the form of, or part of, a label or pressure sensitive sticker that is affixed to the inner surface of the shrink sleeve label.

In the embodiment shown in the Figures (and as described above), the smart component may be associated with a shrink sleeve label prior to application of the shrink sleeve label to an article. In such an embodiment, one will position the smart component relative to a shrink film (that is to be formed into a shrink sleeve label) prior to formation of the shrink sleeve label. Typically, a shrink film is printed flat, and then seamed into a sleeve slightly less than half the width of the shrink film. In certain embodiments, it may be desirable to place the smart component relative to the shrink film in manner aligned approximately in the middle of the finished roll—otherwise the roll will be conical in shape and it will be difficult to control the web including the shrink sleeve labels. Thus, in such an embodiment, it may be desirable to locate the smart component at least ¼ of the width of the film from one edge of the unseamed film. As a result, when the roll is seamed into a shrink sleeve label (or plurality of shrink sleeve labels), the smart component (or components) will be located inside the shrink sleeve label (or labels), roughly centered in the final shrink sleeve label roll. Another benefit provided by this placement of the smart tag is that it can help lessen any pressure put on the smart tag (or any pressure-sensitive area thereof). This can be accomplished because placing the smart tag a distance from the edge of the film will prevent the smart tag from being located in the overlapped edge area of the shrink sleeve once the sleeve has been formed. When wound on a roll, this edge area builds up to a greater thickness than the remainder of the roll, and so locating the smart tag away from the edge avoids this higher pressure area.

Additionally, locating the tag in a manner that it will not be present in the overlapped area of the shrink sleeve also avoids any additional pressure that may be applied by the greater thickness of the overlapped area, and any overlapping and seaming process.

Further, in certain embodiments, the smart component may be located on the same side of the finished shrink sleeve label as the barcode, though it may be desirable for the smart component to not be located under the barcode itself (as placement under the barcode may risk distortion during winding of the roll of labels).

In an alternate embodiment, the component may be applied to the article or packaging prior to application of a label to the article or packaging. In this embodiment, the smart component is first positioned within a relief that is present in or on an article or packaging (or have a pressure-sensitive portion thereof aligned with a relief). Once so positioned, the article or packaging may then be labeled, such that a label is positioned over the relief and component. The label may be a shrink sleeve label, pressure sensitive label, or other type of label in accordance with the principles of the present invention.

Regarding various embodiments of the relief itself: The relief may be an indentation into the surface of the article that can receive the smart component, and may be deeper than the thickness of the smart component, for example. Alternatively, the relief may include an indentation around the periphery of the article (e.g., an annular indentation disposed axially in the case of a bottle having a circular cross-section), so as to provide the relief for the smart component regardless of radial orientation of the shrink film. Alternatively, the relief may be disposed vertically (i.e., parallel to a longitudinal axis of the article) in and-or around the article. Still alternatively, a relief may be formed along the pull lines of a mold to facilitate removal from a molding device and minimize tool complexity and cost. Alternatively to being sized to receive the entire smart component, the relief may be sized to underlie a pressure-sensitive portion of the smart component, thereby preventing the application of pressure that could otherwise disrupt functionality of the component.

Conversely, a mound, bump(s) or ridge(s) may be formed on the surface of the bottle to create local relief aligned with the component in question. In such an embodiment, the relief is created by adding material to the surface of the article proximal to the area where the relief is to be located. By adding such material, a raised area is created proximal to, or surrounding, the area for the relief—thereby providing a raised mound(s), bump(s), or ridge(s), which forms the relief within the raised mound(s), bump(s), or ridge(s).

Other embodiments (in accordance with aspects of the present invention) may not rely on the use of a relief to prevent too much stress from being applied to a smart component. For example, and referring now to FIG. 3, one embodiment may include a smart component 12 positioned within the layers 10, 11 of a label to be applied to an article or packaging. In this embodiment, it would not be necessary to include a relief in or on a surface of the article or packaging. In this embodiment, a label may include multiple layers. These multiple layers may include at least a first layer 10 (that will be an outer layer of the label once the label is applied to an article or packaging) and a second layer 11 (that will be positioned between the first layer and the article or packaging once applied). In a particular embodiment, the second layer 11 may have a cutout region 13 therein. The cutout region provides a void. The smart component 12 (such as an EAS tag) may be positioned in the void defined by the cutout region 13. The label (including smart component in cutout region) may then be applied to an article or packaging, such as via an adhesive, which may be present in an adhesive layer. The label may be a pressure sensitive label, a shrink sleeve label, or any other label in accordance with the principles of the present invention.

In alternate embodiments of FIG. 3, there may be an additional film layer or layers, each having a cutout region that can be in register with the cutout region of film layer 11. Thus, the smart component may only be partially in void provided by cutout region of layer 11. A remainder of the smart component may be positioned in cutout regions of other layers.

The various aspects of the present invention allow smart components (e.g., EAS tags, RFID tags, NFC tags, IoT tags) to be associated with articles or packaging in a manner that reduces or eliminates the risk of diminished performance or functionality of the components.

In addition, the use of relief in the article or packaging—or the use of a cutout region in a layer of a label—allows for reduced (or eliminated) visibility of the smart component such that it is harder to distinguish with the naked eye. This, in turn, minimizes the ability of disabling the component surreptitiously. Since many of these components are not only used for logistics or inventory, but also used for security purposes, this can be a benefit.

While the present invention has been disclosed by reference to the details of preferred embodiments of the invention, it is to be understood that the disclosure is intended as an illustrative rather than in a limiting sense, as it is contemplated that modifications will readily occur to those skilled in the art, within the spirit of the invention and the scope of the amended claims.

What is claimed is:

1. A label, comprising:
a first layer and a second layer;
wherein the second layer includes a region therein that provides a void; and
a smart component positioned at least partially in the void.

2. The label of claim 1, further comprising an adhesive layer.

3. The label of claim 2, wherein the adhesive layer is adjacent to the second layer, so that the second layer is positioned between the first layer and the adhesive layer.

4. The label of claim 1, further comprising a third layer positioned adjacent the second layer, so that the second layer is positioned between the first layer and third layer.

5. The label of claim 4, wherein the third layer includes a second region therein that provides a second void.

6. The label of claim 5, wherein at least a portion of the first void and a portion of the second void are in register with one another.

7. The label of claim 6, wherein the smart component is positioned at least partially in both the first void and the second void.

8. The label of claim 1, wherein the first layer includes a shrink film.

9. The label of claim 8, wherein the second layer includes a shrink film.

10. An article comprising:
at least one outer surface;
a relief defined by the at least one outer surface; and
a smart component positioned at least partially in the relief.

11. The article of claim 10, wherein the relief is an annular indentation defined circumferentially around the at least one surface.

12. The article of claim 10, wherein the smart component includes a pressure-sensitive area.

13. The article of claim 12, wherein the pressure-sensitive area is positioned in the relief.

14. The article of claim 10, further comprising a label affixed to the at least one outer surface.

15. The article of claim 14, wherein the smart component is positioned between the at least one outer surface and the label.

16. The article of claim 14, further comprising an adhesive positioned between the at least one outer surface and the label.

17. The article of claim 14, wherein the label includes a shrink film.
